(19) United States
(12) Patent Application Publication
(10) Pub. No.: US 2011/0147540 A1
(43) Pub. Date: Jun. 23, 2011

(54) Mounting Arrangement For Connecting Components To A Machine

(75) Inventors: Dominick B. Rivara, Peoria, IL (US); Scott W. Glaser, Lacon, IL (US)

(73) Assignee: Caterpillar Inc., Peoria, IL (US)

(21) Appl. No.: 12/640,310

(22) Filed: Dec. 17, 2009

(51) Int. Cl. F16L 3/22; F16B 17/00

(52) U.S. Cl. 248/68.1; 403/345

(57) ABSTRACT

A mounting arrangement for connecting components, such as a wiring harness or hydraulic lines, to a machine may include a planar attachment portion, a neck portion extending from the planar attachment portion, and a head portion extending from the neck portion. The head portion includes an end, a main section, and one or more retention ears extending from the main section and disposed adjacent the end. Further, the planar attachment portion, the neck portion, and the head portion are unitarily formed.

### TECHNICAL FIELD

The invention relates to a mounting arrangement, and more specifically, relates to a mounting arrangement for connecting components to a machine.

### BACKGROUND

Wires or cables are broadly used for electrical communications and providing electrical power in a machine. Additionally, hydraulic hoses may be routed throughout a machine to provide hydraulic fluid. Generally, a fastener is applied to these wires or cables to facilitate the routing of the wire, cables, or hose through the machine. Currently many different types of fastening points are used on structures, such as weld links, bosses, threaded blocks and so on that are welded to the machine.

U.S. Pat. No. 3,848,839 issued to Tillman (“the '839 patent”) discloses an elastomeric conduit clamp for supporting an elongate relative to a structure. The '839 patent provides a clamp with a ringed shape for cable fastening. However, the space available may not permit such a clamp. Furthermore, the closed ring shape limits the number of cables, wires, or hose that may be fastened.

### SUMMARY OF THE DISCLOSURE

In one aspect, the present disclosure is directed to a mounting arrangement for connecting components to a machine. The mounting arrangement may comprise a planar attachment portion shaped to attach the mounting arrangement to the machine and a neck portion extending from the planar attachment portion. The mounting arrangement may further include a head portion extending from the neck portion, and the head portion may include an end, a main section, and one or more retention ears extending from the main section disposed adjacent the end. The planar attachment portion, the neck portion, and the head portion are unitarily formed.

In another aspect, the present disclosure is directed to a machine comprising a frame. The machine may comprise a plurality of machine components connected by a wiring harness or hydraulic lines. The machine may further comprise a plurality of mounting arrangements attached to the frame, which includes a planar attachment portion, a neck portion extending from the planar attachment portion, and a head portion extending from the neck portion. The machine may further comprise a plurality of securing devices connecting the wiring harness or hydraulic lines to the plurality of mounting arrangements. The head portion of the plurality of mounting arrangements includes an end, a main section, and one or more retention ears extending from the main section disposed adjacent the end.

### BRIEF DESCRIPTION OF THE DRAWINGS

FIG. 1 is a perspective view of an exemplary mounting arrangement for connecting components to a machine according to the present disclosure.

FIG. 2 is a perspective view of an assembly for connecting the mounting arrangement of FIG. 1 to the machine according to the present disclosure.

### DETAILED DESCRIPTION

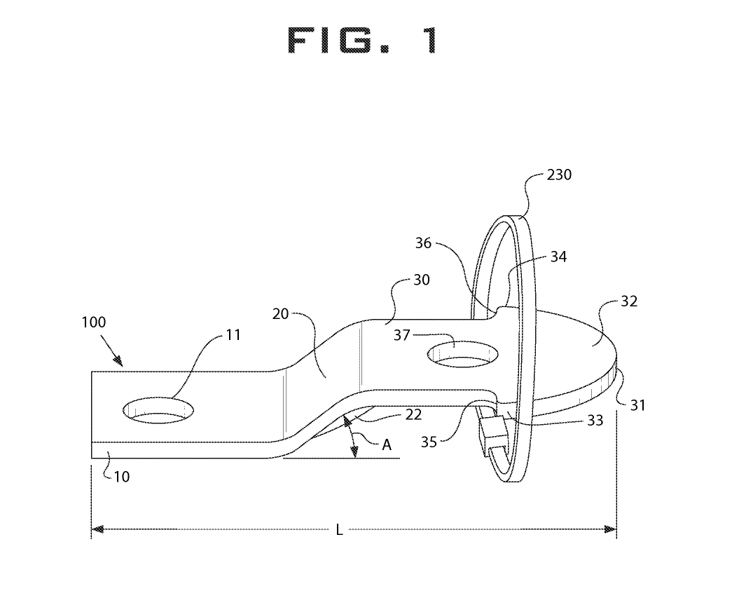

FIG. 1 shows a perspective view of an exemplary mounting arrangement 100 in accordance with the present disclosure. Mounting arrangement 100 may include planar attachment portion 10, neck portion 20 and head portion 30. Planar attachment portion 10, neck portion 20, and head portion 30 may be unitarily formed.

Planar attachment portion 10 facilitates easily attaching mounting arrangement 100 to machine and eliminating a rub-point. In one embodiment, planar attachment portion 10 is connected to machine by welding, such as plug welding, spot welding and bonding. In addition, planar attachment portion 10 may further include an aperture 11, which allows a threaded connection with machine. Alternatively, planar attachment portion 10 may also be rigidly connected to a machine by an adhesive.

As shown in FIG. 1, neck portion 20 of mounting arrangement 100 extends from planar attachment portion 10 at a non-parallel angle.

The head portion 30 extends from neck portion 20 and may include an end 301, a main section 302, and retention ears 36. Head portion 30 may be planar and extend generally parallel to planar attachment portion 10. Planar attachment portion 10, neck portion 20, and head portion 30 may be unitarily formed. In one embodiment, in order to strengthen mounting neck portion 20, one or more gussets may be included.

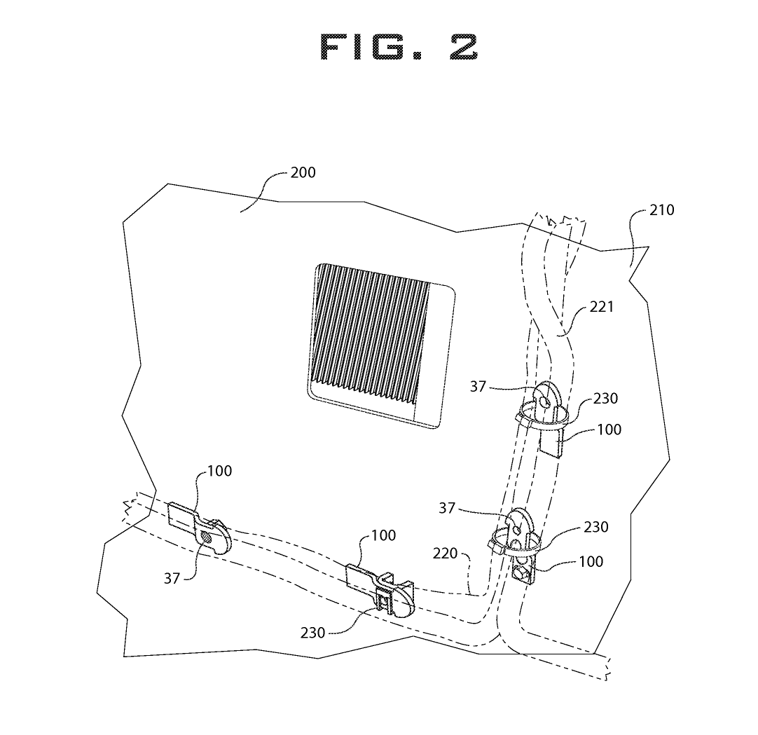

The retention ears 36 may include a first retention ear 33 and second retention ear 34 that project from main section 32 and may be disposed adjacent end 31, being opposite to each other about the main section 32. End 31 may be curved and such curve may start from first retention ear 33 and end at second retention ear 34. As can be seen in FIG. 1, mounting arrangement 100 has a length. The first and second retention ears 33, 34 may include a retention surface 35 that extends perpendicular to the length for preventing securing device 230 (shown in FIG. 2) from disconnecting from head portion 30.

FIG. 2 illustrates an exemplary partial portion of a machine 200, which may include frame 210. Machine 200 may be configured to perform an operation associated with a particular industry, such as mining, construction, farming, etc. Other examples of machines may include, but should not be limited to, vocational machines, such as trucks, cranes, earth moving vehicles, mining vehicles, backhoes, material handling equipment, farming equipment, marine vessels, aircraft, and any type of movable machine. Machine 200 may be powered by a combustion engine, an electric motor, or any other propulsion means known to those skilled in the art.

Machine 200 also includes a plurality of components (not shown) connected by a wiring harness or hydraulic conduit 210. As shown in FIG. 2, planar attachment portion 10 of mounting arrangement 100 may be fixed to frame 210 of machine, by adhesive, welding or fastener. The fixed location may be pre-determined based on the layout of components on machine 200. Securing device 230, such as a cable tie, may be provided to hold wiring harness 220 at the required location to follow the layout. As illustrated above, retention ears 36 of mounting arrangement 100 enables a reliable connection between wiring harness 220 and mounting arrangement 100.

To satisfy different mounting environments, head portion 30 of mounting arrangement 100 may vary. In the embodiments illustrated in FIG. 2, the head portion 30 may further include a hole for receipt of a tinnerman clip, a weld nut or zip tie. The length of mounting arrangement 100 may also be different in various assembly circumstances. In some instances, it could be in the range of 35-50 mm.

### INDUSTRIAL APPLICABILITY

The disclosed mounting arrangement may be applicable to connecting components to a machine. The mounting arrangement may include a planer attachment portion, a neck portion and a head portion. Further, the planer attachment portion, the neck portion and the head portion may be unitarily formed. The planar attachment portion of mounting arrangement may be attached to frame of a machine. An assembly worker may position a wiring harness or hydraulic hose near a mounting arrangement and secure it to the head portion of the mounting arrangement with a securing device, such as a twist tie, clip, tinnerman clip, and other fasteners known in the art. The retention ears of the head portion may engage the securing device to prevent disconnection from mounting arrangement. The disclosed mounting arrangement benefits the assembly work by providing faster assembly and by not requiring a securing device to be fished through a fastening point such as a solid metal ring while holding wiring harness in place.

It is contemplated that the three portions of mounting arrangement may be altered for optimized use in different applications and different circumstances. Therefore, the manufacture process for mounting arrangement may include a two part, two station progressive die for forming the head portion and the planar attachment portion respectively. This allows decreasing the manufacture cost, and in the meantime increasing the universal application of the mounting arrangement.

What is claimed is:

1. A mounting arrangement for connecting components to a machine, the mounting arrangement comprising:
a planar attachment portion shaped to attach the mounting arrangement to the machine;
a neck portion extending from the planar attachment portion;
a head portion extending from the neck portion, the head portion including an end, a main section, and one or more retention ears extending from the main section disposed adjacent the end; and
wherein the planar attachment portion, the neck portion, and the head portion are unitarily formed.

2. A mounting arrangement of claim 1, wherein the neck portion includes one or more gussets.

3. A mounting arrangement of claim 1, wherein the head potion further includes an opening extending through the main section.

4. A mounting arrangement of claim 1, wherein the planar attachment portion further includes an aperture.

5. A mounting arrangement of claim 1, wherein the head portion is planar and extends generally parallel to the planar attachment portion.

6. A mounting arrangement of claim 1, wherein the head portion includes a first retention ear and a second retention ear disposed opposite the first retention ear about the main section.

7. A mounting arrangement of claim 1, wherein the end of the head portion is curved.

8. A mounting arrangement of claim 7, wherein the curve of the end of the head portion extends from the first retention ear to the second retention ear.

9. A mounting arrangement of claim 8, wherein the mounting arrangement has a length, wherein the first and the second retention ears include a retention surface that extends perpendicular to the length for preventing a retention device from disconnecting from the head portion.

10. A mounting structure of claim 6, wherein the mounting structure has a length, wherein the first and the second retention ears include a retention surface that extends perpendicular to the length for preventing a retention device from disconnecting from the head portion.

11. A machine comprising:
a frame;
a plurality of machine components connected by a wiring harness or hydraulic lines;
a plurality of mounting arrangements attached to the frame, includes a planar attachment portion, a neck portion extending from the planar attachment portion, and a head portion extending from the neck portion;
a plurality of securing devices connecting the wiring harness or hydraulic lines to the plurality of mounting arrangements; and
wherein the head portion of the plurality of mounting arrangements includes an end, a main section, and one or more retention ears extending from the main section disposed adjacent the end.

12. A machine of claim 11, wherein the plurality of mounting arrangements are attached to the frame by an adhesive.

13. A machine of claim 11, wherein the plurality of mounting arrangements are attached to the frame by a weld.

14. A machine of claim 11, wherein the plurality of mounting arrangements are attached to the frame by a fastener extending through the attachment portion.
